(19) United States
(12) Patent Application Publication
(10) Pub. No.: US 2021/0119195 A1
(43) Pub. Date: Apr. 22, 2021

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Byung-Soo KIM, Suwon-si (KR); Jaehyun CHO, Suwon-si (KR)

(21) Appl. No.: 17/070,773

(22) Filed: Oct. 14, 2020

(30) Foreign Application Priority Data
Oct. 16, 2019 (KR) 10-2019-0128687

(51) Int. Cl. H01M 2/16; H01M 10/052

(52) U.S. Cl. CPC H01M 2/166; H01M 2/1673; H01M 10/052

(57) ABSTRACT

A separator for a rechargeable lithium battery including a porous substrate and a heat resistant layer on at least one surface of the porous substrate is disclosed. The heat resistant layer includes a crosslinked binder and a filler, the crosslinked binder includes a crosslinked polymer of an urethane-based compound including at least three curable functional groups and having a molecular weight of greater than or equal to about 10,000, and a (meth)acrylate-based compound including at least two curable functional groups and a molecular weight of less than or equal to about 1,000. The filler includes silica particles having a functional group on the surface. The functional group is selected from a (meth)acrylate group, a vinyl group, a hydroxy group, an epoxy group, an oxane group, an oxetane group, an ester group, and an isocyanate group. A rechargeable lithium battery including the separator is also disclosed.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. For example, this application claims priority to and the benefit of Korean Patent Application No. 10-2019-0128687 filed in the Korean Intellectual Property Office on Oct. 16, 2019, the entire contents of which are incorporated herein by reference.

### BACKGROUND

### Field of the Disclosure

A separator for a rechargeable lithium battery and a rechargeable lithium battery including the same are disclosed.

### Description of the Related Art

Recent research on a rechargeable lithium batteries has focused on increasing battery energy density. This research has improved the usefulness of rechargeable lithium batteries as a power source for a portable electronic devices. In addition, since electric vehicles are viewed as being more environmentally friendly than gas-powered vehicles, there is increasing interest in combining rechargeable lithium battery technology as a power source for electric vehicles.

A rechargeable lithium battery includes a positive electrode, a negative electrode, and a separator interposed between the positive and negative electrodes. The separator plays a role of electrically insulating the positive and negative electrodes as well as including micropores through which lithium ions are transferred.

A separator keeps being required of excellent battery stability about exothermicity, as a battery tends to be lighter and down-sized and keeps requiring of high capacity as a power source having high power/large capacity for the electric vehicle.

For this purpose, a separator formed by coating a binder resin and ceramic particles on a porous substrate is most common. However, this type of separator may does not have good stability due to shrinkage during overheating.

### SUMMARY

In one aspect, a separator for a rechargeable lithium battery having excellent heat resistance and a binding force for a substrate is provided.

In another aspect, a rechargeable lithium battery including the separator is provided.

In another aspect, a separator for a rechargeable lithium battery is provided. The separator may include, for example, a porous substrate, and a heat resistant layer on at least one surface of the porous substrate. In some embodiments, the heat resistant layer includes a crosslinked binder and a filler. In some embodiments, the crosslinked binder includes a crosslinked polymer of an urethane-based compound including at least three curable functional groups and having a molecular weight of greater than or equal to about 10,000, and a (meth)acrylate-based compound including at least two curable functional groups and a molecular weight of less than or equal to about 1,000.

In some embodiments, the filler includes silica particles having a functional group on the surface.

In some embodiments, a particle diameter of the silica particles having a functional group on the surface is less than or equal to about 100 nm.

In some embodiments, the functional group is selected from a (meth)acrylate group, a vinyl group, a hydroxy group, an epoxy group, an oxane group, an oxetane group, an ester group, and an isocyanate group.

In another aspect, a rechargeable lithium battery is provided that includes separator for the rechargeable lithium battery from the present disclosure.

In another aspect, a separator for a rechargeable lithium battery has improved heat resistance and binding force for a substrate. In another aspect, a rechargeable lithium battery having excellent thermal stability and safety is provided.

### BRIEF DESCRIPTION OF THE DRAWINGS

FIG. 1 is an exploded perspective view of a rechargeable lithium battery according to an embodiment.

### DETAILED DESCRIPTION OF THE PREFERRED EMBODIMENTS

Hereinafter, embodiments of the present invention are described in detail. However, these embodiments are exemplary, the present invention is not limited thereto and the present invention is defined by the scope of claims.

Hereinafter, a separator for a rechargeable lithium battery according to an embodiment is described.

A separator for a rechargeable lithium battery separates a negative electrode and a positive electrode and provides a passage for lithium ions to move. The separator may include a porous substrate and a heat resistant layer on at least one surface of the porous substrate.

The porous substrate may be a substrate including pores, and lithium ions may move through the pores. The porous substrate may be, for example polyolefin, polyester, polytetrafluoroethylene (PTFE), polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylene sulfide, polyethylenenaphthalene, a glass fiber, or a combination thereof, but is not limited thereto. Examples of the polyolefin may be polyethylene, polypropylene, and the like, and examples of the polyester may be polyethyleneterephthalate, polybutyleneterephthalate, and the like. In addition, the porous substrate may be a non-woven fabric or a woven fabric. The porous substrate may have a single layer or multilayer structure. For example, the porous substrate may be a polyethylene single layer, a polypropylene single layer, a polyethylene/polypropylene double layer, a polypropylene/polyethylene/polypropylene triple layer, a polyethylene/polypropylene/polyethylene triple layer, and the like. A thickness of the porous substrate may be about 1 μm to about 40 for example, about 1 μm to about 30 about 1 μm to about 20 about 5 μm to about 20 or about 5 μm to about 10 When the thickness of the substrate is within the range, short-circuit between positive and negative electrodes may be prevented without increasing internal resistance of a battery.

The heat resistant layer is formed on one or both surfaces of the porous substrate. The heat resistant layer may include a crosslinked binder and a filler.

The crosslinked binder may be formed of a crosslinked system by curing an urethane-based compound including at least three curable functional groups and having a molecular weight of greater than or equal to about 10,000, and a (meth)acrylate-based compound including at least two curable functional groups and a molecular weight of less than or equal to about 1,000 and may be a polymer having a crosslinked structure. The compound including the curable functional group may be a monomer, oligomer, polymer, or a mixture thereof which includes a curable functional group.

Herein, the “curable functional group” refers to a (meth)acrylate group, a vinyl group, a hydroxy group, an ester group, a cyanate group, a carboxyl group, a thiol group, a C1 to C10 alkoxy group, a heterocyclic group, an amino group, or a combination thereof which may react by heat or light. Examples of the heterocyclic group include an epoxy group and an oxetane group.

The urethane-based compound may be a multi-functional urethane-based monomer, oligomer, polymer, or a mixture thereof having at least three curable functional groups.

The urethane-based compound may be a compound including a urethane group and having at least three, for example, five to thirty curable functional groups. By forming a crosslinked binder using the multi-functional urethane-based compound, a separator with improved electrolyte wettability may be secured, and accordingly, a conductivity of lithium ions is increased and an internal resistance is reduced, thereby implementing a rechargeable lithium battery having improved battery performance such as cycle-life characteristics.

The urethane-based compound may be formed by a reaction of a compound having a functional group and an isocyanate compound. The functional group may be a curable functional group, for example, a (meth)acrylate group, a vinyl group, a hydroxy group, an ester group, a cyanate group, a carboxyl group, a thiol group, a C1 to C10 alkoxy group, a heterocyclic group, an amino group, or a combination thereof which may react by heat or light, and specifically among them, the (meth)acrylate group may be used. The ester group may be represented by —COOR and the amino group may be represented by—NR^{a}R^{b}, wherein R, R^{a}, and R^{b} may be a C1 to C20 alkyl group, a C2 to C20 alkenyl group, a C2 to C20 alkynyl group, a C3 to C20 cycloalkyl group, a C3 to C20 cycloalkenyl group, a C4 to C20 cycloalkynyl group, or a C6 to C30 aryl group. In addition, the heterocyclic group may be a C2 to C20 heterocycloalkyl group, a C3 to C20 heterocycloalkenyl group, a C3 to C20 heterocycloalkynyl group, or a C6 to C20 heteroaryl group, for example, an epoxy group, an oxetane group, and the like.

A molecular weight of the urethane-based compound may be about 10,000 g/mol to about 100,000 g/mol, and for example, about 10,000 g/mol to about 80,000 g/mol. When the molecular weight of the urethane-based compound is within the above range, a separator having excellent heat resistance and mechanical strength may be secured, and accordingly, a rechargeable lithium battery having excellent thermal stability and improved cycle-life characteristics and safety by improving adhesion to the substrate may be implemented.

The (meth)acrylate-based compound may be a compound including at least two curable functional groups, and may include, for example, 3 to 20 curable functional groups. Herein, the curable functional group is the same as the type of the aforementioned functional group in the urethane-based compound. Further, the (meth)acrylate-based compound may include at least one oxyethylene group in its main chain.

A molecular weight of the (meth)acrylate-based compound may be about 100 g/mol to about 1,000 g/mol, for example, about 200 g/mol to about 1000 g/mol. When the molecular weight of the (meth)acrylate-based compound is within the above range, a separator having excellent heat resistance may be secured by improving reactivity, and accordingly, a rechargeable lithium battery having excellent thermal stability and improved cycle-life characteristics and safety may be implemented.

According to an embodiment, the crosslinkable compound for forming a crosslinked binder may be a mixture of the urethane-based compound and the (meth)acrylate-based compound to have at least 6 curable functional groups. In other words, for example, a urethane-based compound having at least three curable functional groups and a (meth)acrylate-based compound having at least two curable functional groups may be mixed so as to total at least curable functional groups.

Specifically, by using a crosslinked binder formed by curing from a crosslinkable compound having 6 or more curable functional groups, a crosslinking property is improved and a separator having excellent heat resistance is formed. A rechargeable lithium battery including the separator has improved thermal stability when the battery is ignited. A rechargeable lithium battery including the separator also has improved thermal stability when the battery experiences overheating. Thus, in some embodiments of the present disclosure the crosslinkable compound used to form the separator may include 6 to 30 curable functional groups.

More specifically, the crosslinkable compound may be used by mixing a urethane acrylate compound having at least five (meth)acrylate groups and a (meth)acrylate compound having at least five (meth)acrylate groups. In addition, a mixture of a urethane acrylate having at least 10 (meth)acrylate groups and a (meth)acrylate compound having at least 5 (meth)acrylate groups may be used. In addition, a mixture of a urethane acrylate having at least 15 (meth)acrylate groups and a (meth)acrylate compound having at least 5 (meth)acrylate groups may be used.

In this way, when a crosslinkable compound including at least 6 curable functional groups, desirably at least 10 curable functional groups, more desirably at least 15 curable functional groups, or most desirably at least 20 curable functional groups is used to form a crosslinking system, a separator having a heat resistant layer formed by using this crosslinked binder on a substrate may exhibit excellent heat resistance, mechanical strength, and electrolyte wettability. Accordingly, a rechargeable lithium battery having improved thermal stability, cycle-life characteristics and safety may be implemented.

The urethane-based compound and the (meth)acrylate-based compound may be included in a weight ratio of about 10:90 to about 90:10.

According to an embodiment, the urethane-based compound and the (meth)acrylate-based compound may be included in a weight ratio of about 20:80 to about 80:20, and specifically, a weight ratio of about 30:70 to about 70:30, for example about 40:60 to about 60:40.

For example, the urethane-based compound and the (meth)acrylate-based compound may be included in a weight ratio of about 50:50.

The filler may include silica particles having a functional group on the surface.

The functional group may be selected from a (meth)acrylate group, a vinyl group, a hydroxy group, an epoxy group, an oxane group, an oxetane group, an ester group, and an isocyanate group.

According to an embodiment, the functional group may be a (meth)acrylate group.

The silica particles having the functional group on the surfaces are included in the filter and thus may increase compatibility of the filler with the crosslinked binder in the composition for a heat resistant layer and also, form an additional crosslinking bond and thus has an increased bonding force with ceramic further included in the porous substrate and the filler due to the high crosslinking degree and resultantly, may further increase heat resistance of the separator.

In addition, the silica particles having the functional group on the surfaces have a particle diameter of less than or equal to about 100 nm.

According to an embodiment, the silica particles having the functional group on the surfaces may have a particle diameter in the range of about 10 nm to about 100 nm, specifically, about 10 nm to about 90 nm, for example, about 15 nm to about 90 nm.

When the silica particles having the functional group on the surfaces have a particle diameter within the ranges, an effect of planarizing surface roughness and thereby, suppressing a side reaction according to the charge/discharge of a battery may be obtained.

In addition, since the silica particles may be densely packed on the heat resistant layer, an effect of improving heat resistance properties may be obtained.

In the present specification, a particle diameter may denote an average particle diameter, and the average particle diameter may be a particle size (D50) corresponding to a volume ratio of about 50% in a cumulative size-distribution curve.

The filler may be included in an amount of about 50 wt % to about 97 wt %, for example, about 60 wt % to about 97 wt % based on a total weight of the heat resistant layer, specifically, a total weight of the crosslinked binder and the filler. When the filler is included within the ranges, battery performance may be improved by preventing shrinkage of the substrate due to heat and suppressing a short circuit between positive and negative electrodes.

The filler may further include ceramic, organic particles, or a combination thereof, for example, further the ceramic.

When the filler is a mixture of the silica particles having the functional group on the surfaces and the ceramic, the silica particles having the functional group on the surfaces and the ceramic may be included in the weight ratio of about 2:8 to about 8:2.

According to an embodiment, the silica particles having the functional group on the surfaces and the ceramic may be included in a weight ratio of about 2:8 to about 7:3, about 3:7 to about 7:3, about 3:7 to about 6:4, or about 3:7 to about 5:5.

For example, the silica particles having the functional group on the surfaces and the ceramic may be included in a weight ratio of 5:5 or about 3:7.

The ceramic may be Al₂O₃, B₂O₃, Ga₂O₃, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The ceramic may have an average particle diameter ranging from about 1 nm to about 2000, for example, about 100 nm to about 1000 nm, or about 100 nm to about 700 nm. In addition, the ceramic may be a mixture of at least two ceramics having different particle diameters. When the ceramic has an average particle diameter within the ranges, the heat resistant layer may be uniformly coated on the substrate. In this position the ceramic may function to suppress a short circuit between the positive and negative electrodes, and in addition, minimize resistance of lithium ions to so as to improve performance of a rechargeable lithium battery.

The organic particles may include an acryl-based compound, an imide-based compound, an amide-based compound, or a combination thereof, but are not limited thereto. In addition, the organic particles may have a core-shell structure, but are not limited thereto.

The heat resistant layer may further include a non-crosslinked binder in addition to the crosslinked binder. The non-crosslinked binder may be for example a vinylidenefluoride-based polymer, polymethylmethacrylate, polyacrylonitrile, polyvinylpyrrolidone, polyvinylacetate, polyethylene-vinylacetate copolymer, polyethyleneoxide, cellulose acetate, cellulose acetate butyrate, cellulose acetate propionate, cyanoethylpullulan, cyanoethylpolyvinyl alcohol, cyanoethyl cellulose, cyanoethylsucrose, pullulan, carboxylmethyl cellulose, an acrylonitrile-styrene-butadiene copolymer, or a combination thereof, but is not limited thereto.

The vinylidenefluoride-based polymer may be specifically a homopolymer including only vinylidene fluoride monomer-derived unit, or a copolymer including a vinylidene fluoride-derived unit and other monomers-derived units. The copolymer may be specifically a vinylidene fluoride-derived unit and at least one unit derived from chlorotrifluoroethylene trifluoroethylene, hexafluoropropylene, ethylene tetrafluoride, and an ethylene monomer, but is not limited thereto. The copolymer may be a polyvinylidene fluoride-hexafluoropropylene (PVdF-HFP) copolymer including a vinylidene fluoride monomer-derived unit and a hexafluoropropylene monomer-derived unit.

For example, the non-crosslinked binder may include a polyvinylidene fluoride (PVdF) homopolymer, a polyvinylidene fluoride-hexafluoropropylene (PVdF-HFP) copolymer, or a combination thereof. In this case, adherence between the porous substrate and the coating layer is improved, stability of the separator and the impregnation of the electrolyte are improved, so that high rate charge/discharge characteristics of the battery may be improved.

The heat resistant layer may have a thickness of about 0.01 μm to about 20 μm, for example, about 1 μm to about 10 μm, or about 1 μm to about 5 μm. When the thickness of the heat resistant layer is within the above range, heat resistance is improved, so that a short circuit inside the battery may be suppressed, a stable separator may be secured, and an increase in internal resistance of the battery may be suppressed.

The separator for a rechargeable lithium battery according to an embodiment may be manufactured by various known methods. For example, a separator for a rechargeable lithium battery may be formed by coating a composition for forming a heat resistant layer on one or both sides of a porous substrate and then drying it.

The composition for forming the heat resistant layer may include a urethane compound, a (meth)acryl-based compound, a filler, an initiator, and a solvent.

First, a composition for forming a heat resistant layer including a urethane compound, a (meth)acryl-based compound, a filler, an initiator, and a solvent is coated on at least one surface of the substrate.

Specifically, the composition for forming a heat resistant layer may be prepared by mixing the urethane-based compound, the (meth)acryl-based compound, the filler, the initiator, and the solvent and stirring the mixture at about 10° C. to about 40° C. for about 30 minutes to about 5 hours. Herein, about 1 to about 30 wt % of the urethane-based compound and the balance amount of the solvent and about 1 to about 30 wt % of the (meth)acryl-based compound and the balance amount the solvent are mixed to prepare a binder solution, about 1 to about 30 wt % of silica having the functional group on the surface and the balance amount of the solvent are mixed to prepare inorganic dispersion, and the binder solution and the inorganic dispersion are mixed at room temperature for about 30 minutes to about 5 hours, and then, about 1 to about 10 parts by weight, for example, about 1 to about 5 parts by weight of the initiator based on 100 parts by weight of the binder solution for forming the crosslinked binder may be mixed therewith.

The solvent may include alcohols such as methanol, ethanol, isopropylalcohol, and the like. The solvent may include ketones such as acetone and the like or even water. Other solvents may also be used so long as they function to dissolve the urethane-based compound, the (meth)acryl-based compound, and the filler.

The initiator may be a photoinitiator, a thermal initiator, or a combination thereof.

The photoinitiator may be used when curing by photopolymerization using ultraviolet rays or the like. Examples of the photoinitiator may include acetophenones such as diethoxyacetophenone, 2-hydroxy-2-methyl-1-phenylpropan-1-one, benzyldimethylketal, 1-hydroxycyclohexyl-phenylketone, 2-methyl-2-morpholine (4-thiomethylphenyl)propan-1-one, and the like; benzoin ethers such as benzoinmethylether, benzoinethylether, benzoinisopropylether, benzoinisobutylether, and the like; benzophenones such as benzophenone, o-benzoyl methyl benzoate, 4-phenylbenzophenone, 4-benzoyl-4′-methyldiphenyl sulfurous acid, 4-benzoyl-N,N-dimethyl-N-[2-(1-oxo-2-propenyloxy)ethyl] benzene metanaminium bromide, (4-benzoylbenzyl)trimethylammoniumchloride, and the like; thioxanthones such as 2,4-diethylthioxanthone, 1-chloro-4-dichlorothioxanthone, and the like; 2,4,6-trimethylbenzoyldiphenylbenzoyloxide, and the like. These may be used alone or as a mixture of two or more.

The thermal initiator may be used when curing by thermal polymerization. As the thermal initiator, organic peroxide free radical initiators such as diacyl peroxides, peroxy ketals, ketone peroxides, hydroperoxides, dialkyl peroxides, peroxy esters, and peroxy dicarbonates may be used. For example, lauroyl peroxide, benzoyl peroxide, cyclohexanone peroxide, 1,1-bis(t-butylperoxy)-3,3,5-trimethylcyclohexane, t-butylhydroperoxide, and the like may be used alone or in combination of two or more.

The composition for forming the heat resistant layer may further include ceramic, such as one of the ceramics described above.

The stirring may be performed with a ball mill, a beads mill, a screw mixer, and the like.

The composition for the heat resistant layer may be coated on the substrate using a method of dip coating, die coating, roll coating, comma coating, and the like, but the present disclosure is not limited thereto.

In addition, after coating the composition for forming a heat resistant layer, a drying process may be further performed. The drying process may be performed at a temperature of about 80° C. to about 100° C. for about 5 seconds to 60 seconds, and batch or continuous drying may be applicable.

Then, the coated composition for forming the heat resistant layer is cured to form a heat resistant layer.

The curing may be performed by photocuring, thermal curing, or a combination thereof. The photocuring may be, for example, performed by irradiating UV rays of about 150 nm to about 170 nm for about 5 seconds to about 60 seconds. In addition, the thermal curing may be performed at a temperature of about 60° C. to about 120° C. for about 1 hour to about 36 hours, for example, at a temperature of about 80° C. to about 100° C. for about 10 hours to about 24 hours.

The heat resistant layer may be formed on a substrate in a method of lamination, coextrusion, and the like in addition to the coating of the coating composition.

Hereinafter, a rechargeable lithium battery including the separator for the rechargeable lithium battery is described.

A rechargeable lithium battery may be classified into a lithium ion battery, a lithium ion polymer battery, and a lithium polymer battery depending on kinds of a separator and an electrolyte. It also may be classified to be cylindrical, prismatic, coin-type, pouch-type, and the like, depending on shape. In addition, it may be bulk type and thin film type, depending on sizes. Structures and manufacturing methods for these batteries are well known in the art pertaining to this disclosure.

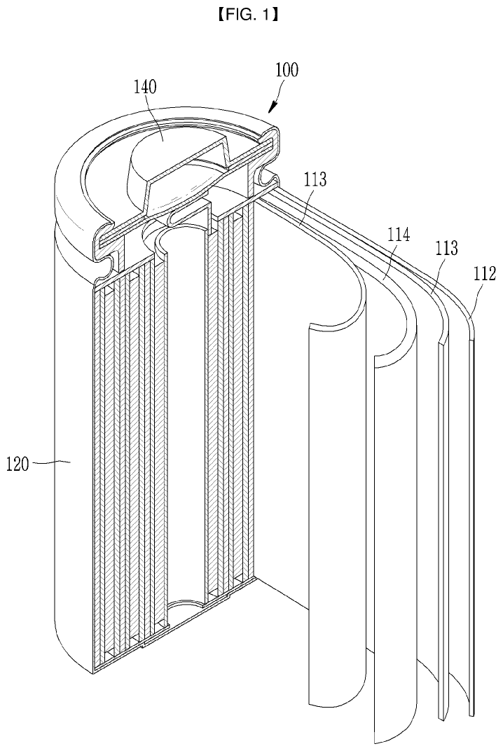

Herein, as an example of a rechargeable lithium battery, a cylindrical rechargeable lithium battery is exemplarily described. FIG. 1 is an exploded perspective view of a rechargeable lithium battery according to an embodiment. Referring to FIG. 1, a rechargeable lithium battery 100 according to one embodiment includes a battery cell including a negative electrode 112, a positive electrode 114 facing the negative electrode 112, a separator 113 between the negative electrode 112 and the positive electrode 114, and an electrolyte (not shown) impregnating the negative electrode 112, the positive electrode 114 and the separator 113, and a battery container 120, a battery case containing the battery cell, and a sealing member 140 that seals the container 120.

The positive electrode 114 may include a positive current collector and a positive active material layer formed on the positive current collector. The positive active material layer includes a positive active material, a binder, and optionally a conductive material.

The positive current collector may use aluminum (Al), nickel (Ni), and the like, but is not limited thereto.

The positive active material may use a compound capable of intercalating and deintercallating lithium. Specifically at least one of a composite oxide or a composite phosphate of a metal selected from cobalt, manganese, nickel, aluminum, iron, or a combination thereof and lithium may be used. More specifically, the positive active material may use lithium cobalt oxide, lithium nickel oxide, lithium manganese oxide, lithium nickel cobalt manganese oxide, lithium nickel cobalt aluminum oxide, lithium iron phosphate, or a combination thereof.

The binder improves binding properties of positive active material particles with one another and with a current collector. Specific examples may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. These may be used alone or as a mixture of two or more.

The conductive material improves conductivity of an electrode. Examples thereof may be natural graphite, artificial graphite, carbon black, a carbon fiber, a metal powder, a metal fiber, and the like, but are not limited thereto. These may be used alone or as a mixture of two or more. The metal powder and the metal fiber may use a metal of copper, nickel, aluminum, silver, and the like.

The negative electrode 112 includes a negative current collector and a negative active material layer formed on the negative current collector.

The negative current collector may use copper, gold, nickel, a copper alloy, but is not limited thereto.

The negative active material layer may include a negative active material, a binder and optionally a conductive material. The negative active material may be a material that reversibly intercalates/deintercalates lithium ions, a lithium metal, a lithium metal alloy, a material capable of doping and dedoping lithium, a transition metal oxide, or a combination thereof.

The material that reversibly intercalates/deintercalates lithium ions may be a carbon material which is any generally-used carbon-based negative active material, and examples thereof may be crystalline carbon, amorphous carbon, or a combination thereof. Examples of the crystalline carbon may be graphite such as amorphous, sheet-shaped, flake-shaped, spherically shaped, or fiber-shaped natural graphite or artificial graphite. Examples of the amorphous carbon may be soft carbon or hard carbon, a mesophase pitch carbonized product, fired coke, and the like. The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn. The material capable of doping and dedoping lithium may be Si, SiOx (0<x<2), a Si—C composite, a Si—Y alloy, Sn, SnO₂, a Sn—C composite, a Sn—Y alloy, and the like, and at least one of these may be mixed with SiO₂. Specific examples of the element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof. The transition metal oxide may be vanadium oxide, lithium vanadium oxide, and the like.

The binder and the conductive material used in the negative electrode 112 may be the same as the binder and conductive material of the positive electrode 114.

The positive electrode 114 and the negative electrode 112 may be manufactured by mixing each active material composition including each active material and a binder, and optionally a conductive material in a solvent, and coating the active material composition on each current collector. Herein, the solvent may be N-methylpyrrolidone, and the like, but is not limited thereto. The electrode manufacturing method is well known, and thus is not described in detail in the present specification.

The electrolyte includes an organic solvent a lithium salt.

The organic solvent serves as a medium for transmitting ions taking part in the electrochemical reaction of a battery. Examples thereof may be selected from a carbonate-based solvent, an ester-based solvent, an ether-based solvent, a ketone-based solvent, an alcohol-based solvent, and an aprotic solvent. The carbonate-based solvent may be dimethyl carbonate, diethyl carbonate, dipropyl carbonate, methylpropyl carbonate, ethylpropyl carbonate, methylethyl carbonate, ethylene carbonate, propylene carbonate, butylene carbonate, and the like, and the ester-based solvent may be methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, and the like. The ether-based solvent may be dibutyl ether, tetraglyme, diglyme, dimethoxyethane, 2-methyltetrahydrofuran, tetrahydrofuran, and the like, and the ketone-based solvent may be cyclohexanone, and the like. The alcohol-based solvent may be ethanol, isopropyl alcohol, and the like, and the aprotic solvent may be nitriles such as R—CN (R is a C2 to C20 linear, branched, or cyclic hydrocarbon group, a double bond, an aromatic ring, or an ether bond), and the like, amides such as dimethyl formamide, dioxolanes such as 1,3-dioxolane, sulfolanes, and the like.

The organic solvent may be used alone or in a mixture of two or more, and when the organic solvent is used in a mixture of two or more, the mixture ratio may be controlled in accordance with a desirable cell performance.

The lithium salt is dissolved in an organic solvent, supplies lithium ions in a battery, basically operates the rechargeable lithium battery, and improves lithium ion transportation between positive and negative electrodes therein. Examples of the lithium salt may include two or more selected from LiPF₆, LiBF₄, LiSbF₆, LiAsF₆, LiN(SO₂C₂F₅)₂, Li(CF₃SO₂)2N, LiN(SO₃C₂F₅)₂, Li(FSO₂)2N ((lithium bis(fluorosulfonyl)imide, LiFSI), LiC₄F₉SO₃, LiClO₄, LiAlO₂, LiAlCl₄, LiN(CₓF₂ₓ₊₁SO₂)(C_{y}F_{2y+1}SO₂), wherein, x and y are natural numbers, for example an integer of 1 to 20), LiCl, LiI, and LiB(C204)2 ((lithium bis(oxalato) borate, LiBOB), but are not limited thereto.

The lithium salt may be used in a concentration ranging from about 0.1 M to about 2.0 M. When the lithium salt is included within the above concentration range, an electrolyte may have excellent performance and lithium ion mobility due to optimal electrolyte conductivity and viscosity.

Hereinafter, the above aspects of the present disclosure are illustrated in more detail with reference to examples. However, these examples are exemplary, and the present disclosure is not limited thereto. Among other things, the Examples illustrate exemplary preparation of separators according to the present disclosure.

### Example 1

30 wt % of an urethane compound having 15 (meth)acrylate groups and a weight average molecular weight of 20,000 g/mol (SC2152, Miwon Specialty Chemical Co., Ltd.) and 70 wt % of acetone were mixed at room temperature for 1 hour to obtain an urethane-based binder solution.

In addition, 30 wt % of a dipentaerythritol hexaacrylate compound having six (meth)acrylate groups and a weight average molecular weight of 600 g/mol (DPHA, Sanopco Co., Ltd.) and 70 wt % of acetone were mixed at room temperature for 1 hour to obtain a (meth)acrylate-based binder solution.

In addition, 25 wt % of SiO₂ substituted with a (meth) acrylate group and having an average particle diameter of 20 nm and 75 wt % of acetone were mixed at room temperature for 1 hour to obtain inorganic dispersion.

Subsequently, a heat resistant layer composition was prepared by mixing the urethane binder solution and the (meth)acrylate-based binder solution in a weight ratio of 5:5 between the urethane compound and the (meth)acrylate compound, mixing the mixture with the inorganic dispersion, so that SiO₂ substituted with the acrylate group might be 95 wt % based on a total amount of an composition, and then, adding 0.03 parts by weight of benzoyl peroxide as an initiator thereto, and stirring the obtained mixture with a power mixer at room temperature for 1 hour.

The prepared heat resistant layer composition was coated in a dip coating method on one surface of a 12 μm-thick polyethylene single-layered film, dried at 80° C. and a wind speed of 15 m/sec for 0.03 hour to form a 3 μm-thick separator, and cured at 80° C. for 10 hours to manufacture a separator.

### Example 2

A separator was manufactured according to the same method as Example 1 except that 95 wt % of inorganic dispersion prepared by mixing SiO₂ substituted with the acrylate group and the alumina having an average particle diameter of 650 nm (Al₂O₃, Nippon Light Metal Co., Ltd.) in weight ratio of 5:5 was used.

### Example 3

A separator was manufactured according to the same method as Example 1 except that 95 wt % of inorganic dispersion prepare by mixing SiO₂ substituted with the methacrylate group and the alumina (Al₂O₃, Nippon Light Metal Co., Ltd.) in weight ratio of 3:7 was used.

### Comparative Example 1

A separator was manufactured according to the same method as Example 1 except that 95 wt % of inorganic dispersion prepared by mixing SiO₂ substituted with the methacrylate group and the alumina (Al₂O₃, Nippon Light Metal Co., Ltd.) in weight ratio of 1:9 was used.

### Comparative Example 2

A separator was manufactured according to the same method as Example 1 except that 95 wt % of inorganic dispersion using the alumina (Al₂O₃, Nippon Light Metal Co., Ltd.) alone was used.

The compositions of the crosslinked binder and the fillers of the heat resistant layer compositions according to the examples and the comparative examples are provided in Table 1.

TABLE 1

| | | | | Comparative | Comparative |
|---|---|---|---|---|---|
| | Example 1 | Example 2 | Example 3 | Example 1 | Example 2 |
| Filler | SiO₂ having a | SiO₂ having a | SiO₂ having a | SiO₂ having a | Alumina |
| (95 wt %) | methacrylate | methacrylate | methacrylate | methacrylate | |
| | group on the | group on the | group on the | group on the | |
| | surface | surface:alumina = | surface:alumina = | surface:alumina = | |
| | | 5:5 wt % | 3:7 wt % | 1:9 wt % | |

| | |
|---|---|
| Crosslinked | A crosslinked binder formed from crosslinked compounds |
| binder | in which a urethane compound and a (meth)acrylate |
| (5 wt %) | compound are mixed in a weight ratio of 5:5 |

### Evaluation 1: Measurement of Surface Roughness

Each surface roughness of the separators according to Examples 1 to 3 and Comparative Examples 1 and 2 was measured, and the results are shown in Table 2.

The surface roughness of each separator was obtained by using Optical profiler ContourGT-K0 Series (Bruker) to calculate arithmetic mean surface roughness Ra according to JIS B0601:1994.

### Evaluation 2: Measurement of Binding Force for Substrate

The separators of Examples 1 to 3 and Comparative Examples 1 and 2 were cut to have a width of 12 mm and a length of 50 mm and obtain samples. After adhering a tape to the coating layer surface of each sample and detaching it about 10 mm to 20 mm from the substrate, the side of the substrate to which the tape was not adhered was fixed into an upper grip, while the side of the coating layer to which the tape was adhered was fixed into the lower grip, with an interval between the two grips of 20 mm and then, elongated and peeled off in a direction of 180°. Herein, the peeling speed was 10 mm/min, and a force required to peel 20 mm after starting the peeling was three times measured and averaged. The peel strength measurement results are shown in Table 2.

### Evaluation 3: Measurement of Heat Resistance

The separators of Examples 1 to 3 and Comparative Examples 1 and 2 were evaluated with respect to heat resistance by measuring a shrinkage rate against heat in the following method, and the results are shown in Table 2.

Each sample of the separators was cut into a size of 10 cm×10 cm and allowed to stand in a convection oven set at 130° C. for 60 minutes to measure each shrinkage rate in MD (machine direction) and TD (vertical direction). The shrinkage rate was calculated according to Equation 1.

Shrinkage rate (%)=[(L0−L1)/L0]×100 Equation 1

In Equation 1, L0 denotes an initial length of a separator, and L1 denotes a length of the separator after allowed to stand at 130° C. for 60 minutes.

TABLE 2

| | | Example | Example | Example | Comparative | Comparative |
|---|---|---|---|---|---|---|
| | | 1 | 2 | 3 | Example 1 | Example 2 |
| Coating thickness (μm) | | 3 | 3 | 3 | 3 | 3 |
| Surface roughness (Ra, nm) | | 0.15 | 0.21 | 0.23 | 0.28 | 0.27 |
| Binding force for a substrate | | 4.5 | 2.8 | 1.9 | 0.4 | 0.01 |
| (N/mm) | | | | | | |
| Shrinkage | 130° C./1 hr | 1 | 2 | 2 | 11 | 13 |
| rate (%) | 130° C./1 hr | 11 | 14 | 15 | 52 | 57 |

Referring to Table 2, the separators of Examples 1 to 3 had relatively smooth surface roughness and exhibited an excellent binding force for a substrate and thus low shrinkage against heat.

Accordingly, the separator including the heat resistant layer including the crosslinked binder and the filler according to an embodiment was expected to exhibit improved stability and heat resistance of a battery cell.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A separator for a rechargeable lithium battery, comprising
a porous substrate; and
a heat resistant layer on at least one surface of the porous substrate,
wherein the heat resistant layer includes a crosslinked binder and a filler,
wherein the crosslinked binder includes a crosslinked polymer of an urethane-based compound including:
at least three curable functional groups and having a molecular weight of greater than or equal to about 10,000, and
a (meth)acrylate-based compound including at least two curable functional groups and a molecular weight of less than or equal to about 1,000,
wherein the filler comprises silica particles, each having a functional group on the surface thereof,
wherein a particle diameter of the silica particles including the functional group on the surface thereof is less than or equal to about 100 nm, and
wherein the functional group is selected from a (meth)acrylate group, a vinyl group, a hydroxy group, an epoxy group, an oxane group, an oxetane group, an ester group, and an isocyanate group.

2. The separator of claim 1, wherein the functional group is a (meth)acrylate group.

3. The separator of claim 1, wherein the silica particles having a functional group on the surface have a particle diameter of about 15 nm to about 90 nm.

4. The separator of claim 1, wherein the filler is included in an amount of about 50 wt % to about 97 wt % based on a total weight of the crosslinked binder and the filler.

5. The separator of claim 1, wherein the filler comprises a ceramic selected from Al₂O₃, B₂O₃, Ga₂O₃, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof.

6. The separator of claim 5, wherein the silica particles having a functional group on the surface and the ceramic are included in a weight ratio of about 2:8 to about 8:2.

7. The separator of claim 1, wherein the urethane-based compound and the (meth)acrylate-based compound are included in a weight ratio of about 10:90 to about 90:10.

8. The separator of claim 1, wherein the urethane-based compound comprises 5 to 30 curable functional groups.

9. The separator of claim 1, wherein the curable functional group is selected from a (meth)acrylate group, a vinyl group, a hydroxy group, an ester group, a cyanate group, a carboxyl group, a thiol group, a C1 to C10 alkoxy group, a heterocyclic group, an amino group, or a combination thereof.

10. The separator of claim 9, wherein the curable functional group is a C1 to C10 alkoxy group.

11. The separator of claim 9, wherein the curable functional group is a heterocyclic group.

12. The separator of claim 9, wherein the curable functional group is an amino group.

13. The separator of claim 1, wherein the functional group is a vinyl group.

14. The separator of claim 1, wherein the functional group is a hydroxy group.

15. The separator of claim 1, wherein the functional group is an epoxy group.

16. The separator of claim 1, wherein the functional group is an oxane group.

17. The separator of claim 1, wherein the functional group is an oxetane group.

18. The separator of claim 1, wherein the functional group is an ester group.

19. The separator of claim 1, wherein the functional group is an isocyanate group.

20. A rechargeable lithium battery comprising
a positive electrode;
a negative electrode; and
the separator of claim 1 disposed between the positive electrode and the negative electrode.
